(19) United States
(12) Patent Application Publication
(10) Pub. No.: US 2015/0138099 A1
(43) Pub. Date: May 21, 2015

(54) Systems, Apparatus, and Methods for Motion Controlled Virtual Environment Interaction

(71) Applicant: Marc Robert Major, Los Angeles, CA (US)

(72) Inventor: Marc Robert Major, Los Angeles, CA (US)

(21) Appl. No.: 14/081,735

(22) Filed: Nov. 15, 2013

(51) Int. Cl. A63F 13/211; G06F 3/041; G06F 3/0487; G06F 3/01

(52) U.S. Cl. CPC A63F 13/211; G06F 3/011; G06F 3/041; G06F 3/0487
USPC 345/173; 345/156

(57) ABSTRACT

Systems, apparatus, and method for providing motion controlled virtual environment interaction are discussed herein. Some embodiments may provide for a mobile device including a display device, a motion detection device, and processing circuitry. The circuitry may be configured to detect various intensities of user movement, such as may be determine based on user motion data captured by an accelerometer, camera, and/or other motion sensor. Based on the intensities of user movement, the mobile device may be configured to advance the user within the virtual environment variable amounts. In some embodiments, the techniques discussed herein may be provided in connection with an exercise game including traversable virtual environments that can be played alone or with other networked devices.

### FIELD

Embodiments of the invention relate, generally, to virtual environment user interaction with mobile devices.

### BACKGROUND

For a variety of reasons, people of all ages often lack the motivation to perform regular exercise despite the known health benefits. Many children, for example, find the virtual environments of computer games to be more interesting and engaging than playing in the real world. Today, computer games are increasingly being developed for mobile devices such that on-the-go access to complex virtual environments is possible. Despite the portability of mobile devices, conventional mobile device applications continue to encourage sedentary user interactions. For example, mobile device applications typically leverage touchscreen inputs provided by a user's hands. In this regard, improved mobile devices capable of motivating more strenuous physical motion or exercise are desirable.

### BRIEF SUMMARY

Through applied effort, ingenuity, and innovation, solutions to improve such mobile devices have been realized and are described herein. Some embodiments may provide for a mobile device including a display device, a motion detection device, and processing circuitry. For example, the motion detection device may include an accelerometer and/or camera. The circuitry may be configured to detect various intensities of user movement, such as may be determine based on user motion data captured by the motion detection device. Based on the intensities of user movement, the mobile device may be configured to advance the user within the virtual environment variable amounts. In some embodiments, the techniques discussed herein may be provided in connection with an exercise game including traversable virtual environments that can be played alone or with other networked devices.

Some embodiments may provide for a mobile device that may include: a display device configured to provide interactive displays; a motion detection device; and circuitry configured to: provide a graphical interface to the display device, wherein the graphical interface includes a view of a virtual environment defining a forward direction; receive user motion data from the motion detection device; determine, based on the user motion data, an actiplacement score indicating an intensity level of user movement; and advance the view of the virtual environment in the forward direction at a variable amount based on the actiplacement score.

In some embodiments, the motion detection device may include an accelerometer. The user motion data may include an X axis magnitude value, a Y axis magnitude value, and a Z axis magnitude value. The circuitry may be further configured to determine the actiplacement score based on one or more of the X axis magnitude value, the Y axis magnitude value, and the Z axis magnitude value.

In some embodiments, the motion detection device may include a camera. The user motion data may include a first image of the user and a second image of the user, wherein the first image may be generated by the camera prior to the second image. The circuitry may be further configured to determine the actiplacement score based on comparing the first image and the second image.

In some embodiments, the mobile device may further include a gyroscope. The circuitry may be further configured to: associate the forward direction with an orientation of the mobile device; receive orientation data from the gyroscope indicating a second orientation of the mobile device; determine, based on the orientation data, a second view of the virtual environment defining a second forward direction; and rotate the view of the virtual environment to the second view.

In some embodiments, the mobile device may further include a touch sensor. The circuitry may be further configured to: receive orientation data from the touch sensor; and determine, based on the orientation data, a second view of the virtual environment defining a second forward direction; and rotate the view of the virtual environment to the second view.

In some embodiments, the circuitry may be further configured to determine a performance score based at least in part on actiplacement scores over time and/or user interaction with the virtual environment via the mobile device.

In some embodiments, the circuitry may be further configured to: determine a user difficulty setting; and advance the view of the virtual environment in the forward direction at the variable amount based on the actiplacement score and the difficulty setting.

In some embodiments, the graphical interface may further include a user avatar. The circuitry configured to advance the view of the virtual environment in the forward direction at the variable amount based on the actiplacement score may include the circuitry being configured to advance the user avatar in the forward direction at the variable amount.

In some embodiments, the circuitry may be further configured to: generate user performance data based at least in part on the user motion data; establish a communication connection with a second mobile device; and provide the user performance data to the second mobile device.

In some embodiments, the circuitry may be further configured to: receive, from a second mobile device, historical user performance data associated with a ghost user; provide a ghost avatar of the ghost user to the view of the virtual environment; and advance the ghost avatar within the view of the virtual environment based on the historical user performance data.

In some embodiments, the circuitry may be further configured to: receive, from a second mobile device, historical user performance data associated with a ghost user; provide a ghost graphical interface to the display device concurrently with the graphical interface, wherein the ghost graphical interface includes a second view of the virtual environment defining a second forward direction; and advance the second view of the virtual environment in the second forward direction at a variable amount based on the historical user performance data.

In some embodiments, the circuitry may be further configured to: receive, from a second mobile device, second user performance data associated with a second user; provide a second user avatar of the second user to the view of the virtual environment; and advance the second user avatar within the view of the virtual environment based on the second user performance data.

In some embodiments, the circuitry may be further configured to: receive, from a second mobile device, second user performance data associated with a second user; provide a second user graphical interface to the display device concurrently with the graphical interface, wherein the second user graphical interface includes a second view of the virtual environment defining a second forward direction; and advance the second view of the virtual environment in the second forward direction at a variable amount based on the second user performance data.

In some embodiments, the circuitry may be further configured to: receive calibration data indicating one or more user motion data values each associated with different intensity levels of user movement; and adjust a programmatic relationship between the actiplacement score and the user motion data based on the calibration data.

Some embodiments may provide for a machine-implemented method for providing motion controlled virtual environment interaction. The method may include: providing, by circuitry, a graphical interface to a display device, wherein the graphical interface includes a view of a virtual environment defining a forward direction; receiving user motion data from a motion detection device; determining, based on the user motion data and by the circuitry, an actiplacement score indicating an intensity level of user movement; and advancing the view of the virtual environment in the forward direction at a variable amount based on the actiplacement score. In some embodiments, the motion detection device may include one or more of an accelerometer and a camera.

In some embodiments, the method may further include: associating the forward direction with an orientation of the mobile device; receiving orientation data from the gyroscope indicating a second orientation of the mobile device; determining, based on the orientation data, a second view of the virtual environment defining a second forward direction; and rotating the view of the virtual environment to the second view.

Some embodiments may include circuitry and/or media configured to implement the methods and/or other functionality discussed herein. For example, one or more processors, and/or other machine components may be configured to implement the functionality discussed herein based on instructions and/or other data stored in memory and/or other non-transitory computer readable media.

These characteristics as well as additional features, functions, and details of various embodiments are described below. Similarly, corresponding and additional embodiments are also described below.

### BRIEF DESCRIPTION OF THE DRAWINGS

Having thus described some embodiments in general terms, reference will now be made to the accompanying drawings, which are not necessarily drawn to scale, and wherein:

FIG. 1 shows an example system, in accordance with some embodiments;

FIG. 2 shows a schematic block diagram of an example mobile device, in accordance with some embodiments;

FIG. 3 shows example mobile device holder, in accordance with some embodiments;”

FIG. 4 shows a mobile device mounted to an exercise machine, in accordance with some embodiments;

FIG. 5 shows a schematic block diagram of example circuitry, in accordance with some embodiments;

FIG. 6 shows a flowchart of an example of a method for providing motion controlled virtual environment interaction, in accordance with some embodiments;

FIG. 7 shows a flowchart of an example of a method for facilitating multiple modes of user motion detection, in accordance with some embodiments;

FIG. 8 shows a flowchart of an example of a method for providing an exercise game, in accordance with some embodiments; and

FIGS. 9-14 show example graphical interfaces, in accordance with some embodiments.

### DETAILED DESCRIPTION

Embodiments will be described more fully hereinafter with reference to the accompanying drawings, in which some, but not all embodiments contemplated herein are shown. Indeed, various embodiments may be implemented in many different forms and should not be construed as limited to the embodiments set forth herein; rather, these embodiments are provided so that this disclosure will satisfy applicable legal requirements. Like numbers refer to like elements throughout.

Some embodiments may provide for a mobile device configured to capture user motion data and to use the user motion data to interact with a graphical interface. For example, the mobile device may include circuitry configured to determine an actiplacement score based on the user motion data. An “actiplacement score,” as used herein, may include a numeric value, magnitude, or the like that may provide an indication of an intensity level of user movement within a defined period of time. As discussed in greater detail herein, in some embodiments, the mobile device may include one or more motion data devices including, but not necessarily limited to, an accelerometer, a camera, and/or other motion sensor. Using such motion detection devices, the mobile device may be configured to capture the user motion data to programmatically determine actiplacement scores. As such, embodiments discussed herein may provide for measuring user exercise levels using a mobile device (e.g., without separate sensor hardware).

In some embodiments, the mobile device may be configured to provide graphical interfaces to a display device. A graphical interface may include views of a virtual environment, such as in connection with a mobile device application and/or (e.g., exercise) game. The views of virtual environments, for example, may include rendered 3D images of locations, pathways, race courses, obstacles, treasures, monsters, user avatars, avatars of other users and/or ghost users, maps, landscapes, environmental features, among other things. The mobile device may be further configured to allow the user to interact with the virtual environments via user motion data captured by the one or more motion detection devices. For example, the mobile device may be configured to advance the view of the virtual environment in a forward direction at variable amounts based on determined actiplacement scores. Here, the rate of traversal within the virtual environment may be based on the intensity of real-life user movement.

A “forward direction,” which as used herein, may refer to the direction the user and/or an avatar of the user is “facing” in the virtual environment as defined by the view of the virtual environment. For example, in a first person view, the forward direction may be defined by the center (e.g., or some other fixed location relative to a display) of the view of the virtual environment in the graphical interface. In another example for a third person view, in which the user may be represented within the virtual environment by an avatar, the forward direction may additionally or alternatively be defined by the direction the avatar is facing (e.g., as may be defined by the avatar's eyes, head, body, and/or combinations thereof). In some embodiments, the discussion herein with respect to forward directions may also be applicable to other (e.g., non-forward) directions. For example, user motion may be configured to “power” reverse motion and/or side motion in alternative or addition to motion in the forward direction.

In that sense, some embodiments may provide for techniques for associating the intensity level of user movement, as indicated and/or defined by the actiplacement score and determined based on the user motion data, with a variable rate of traversal (e.g., in the forward direction) of the user and/or avatar in the virtual environment.

In some embodiments, the mobile device may be configured to change the orientation of the view, such as by rotating the view of the virtual environment. For example, a first view may be rotated a variable amount to a second view (e.g., defining a second forward direction) based on orientation data received from a gyroscope of the mobile device. Here, the mobile device may be configured to operate in a “handheld mode,” where the user may be allowed to freely rotate the mobile device, which may cause a corresponding change in the view of the virtual environment. Alternatively or additionally, the first view may be rotated to the second view based on orientation data received from user inputs, such as to a touch sensor and/or other user input device (e.g., keyboard, controller, keypad, touchpad, mouse, microphone, etc.). Here, the mobile device may be configured to operate in a “workout mode” where the mobile device can be secured to fitness equipment (e.g., an exercise machine) or other object (e.g., such as via a mobile device holder that holds the mobile device, as discussed herein, and/or any other suitable technique).

In some embodiments, the mobile device may be configured to change the orientation of the view based on the orientation data, and concurrently, advance the view of the virtual environment in forward directions at a variable amounts based on actiplacement scores determined based on user motion data. For example, both techniques may be performed, over time, to provide the user with free world exploration of a virtual environment based on user motion (e.g., tracked exercise movements).

In some embodiments, the mobile device may be configured to provide the graphical interface including the virtual environment in connection with one or more applications that enhance user exercise. For example, the user may be presented with various challenges, objectives, obstacles, goals, among other things that may be accomplished via user motions captured as user motion data. In some embodiments, the mobile device may be further configured to provide a performance score based at least in part on user interaction with the virtual environment via the mobile device, such as actiplacement scores over time. For example, the performance score may be defined by the user's ability to complete the various challenges, goals, etc., such as completing a virtual race in a virtual environment that includes a race track. In some embodiments, one or more of such challenges may at least partially include (e.g., among other objectives) the user performing an exercise motion at sufficient intensity and/or duration.

In some embodiments, the mobile device may be configured to establish communication connections with other mobile devices and/or a central system Consumers may compete against others users, such as in real-time and/or asynchronously (e.g., based on historical user performance data of previous gameplay of a ghost user). Additionally or alternatively, the mobile device may be configured to allow consumers to compete against themselves based on historical user performance data. Some embodiments may further provide for user accounts, performance tracking, performance sharing, ranking, replays, and/or related social media functionality that can further enhance user interest in exercise.

### Exemplary Architecture

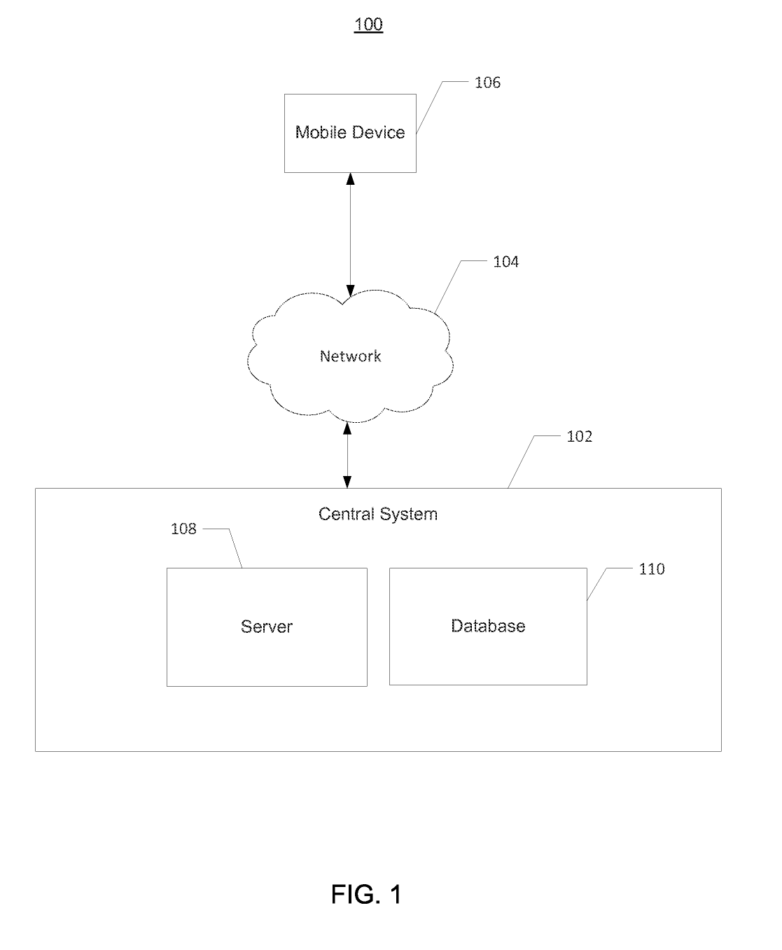

FIG. 1 shows an example system 100 in accordance with some embodiments. System 100 may include central system 102, network 104, and mobile device 106. System 102 may be communicably connected with one or more mobile devices 106 via network 104. System 102 may include server 108 and database 110.

Server 108 may include circuitry, networked processors, or the like configured to perform some or all of the server-based processes described herein and may be any suitable network server and/or other type of processing device. For example, server 108 may be configured to provide application data that can be sent to mobile device 106 for installation and/or execution. The application data, for example, may be loaded into a memory of mobile device 106 and executed by a processor, such as to configure the circuitry of the mobile device to perform the various techniques disclosed herein for motion controlled virtual environment interaction. Alternatively or additionally, the server 108 may be configured to execute the application data and to provide the graphical displays discussed herein to mobile device 106. Server 108 may be further configured to receive user inputs, user motion data, orientation data, and/or touch sensor inputs, etc. from mobile device 106. Accordingly, mobile device 106 may be configured to perform the techniques discussed herein as a fat client, thin client, and/or independently of server 108.

In some embodiments, system 102 may function as a “cloud” with respect to mobile device 106. In that sense, server 110 may include several servers performing interconnected and/or distributed functions. To avoid unnecessarily overcomplicating the disclosure, server 110 is shown and described herein as a single server.

Database 110 may be any suitable network storage device configured to store some or all of the information described herein. For example, database 110 may be configured to store the application data, user data (e.g., user account data, login data, social networking data), user performance data (e.g., historical user performance data, user performance scores, gameplay logs, gameplay video recordings, and/or gameplay recording data that can be stored for subsequent on demand rendering), performance ranking data (e.g., indicating rankings of users based on performance scores determined based on historical performance data of multiple users), among other things. As such, database 110 may include, for example, one or more database systems, backend data servers, network databases, cloud storage devices, etc. To avoid unnecessarily overcomplicating the disclosure, database 110 is shown and described herein as a single database.

Network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (such as, e.g., network routers, switches, hubs, etc.). For example, network 104 may include a cellular telephone, mobile broadband, long term evolution (LTE), GSM/EDGE, UMTS/HSPA, IEEE 802.11, IEEE 802.16, IEEE 802.20, WiFi, dial-up, and/or WiMax network. Furthermore, network 104 may include a public network, such as the Internet, a private network, such as an intranet, or combinations thereof, and may utilize a variety of networking protocols now available or later developed including, but not limited to TCP/IP based networking protocols.

Mobile device 106 may be associated with a user, such as a user that in various embodiments may or may not be associated with a user account provided by system 102. Although a single mobile device 106 is shown, system 100 may include any number of mobile devices that may be associated with various other users and connected with each other via network 104. Mobile device may include a tablet, cellular telephone (including smartphones and/or other types of mobile telephones), laptop, electronic reader, e-book device, media device, and/or the like. In some embodiments, some or all of the techniques discussed herein with respect to mobile device 106 may be applied to a stationary device such as an exercise machine (e.g., stationary bike, treadmill, stepper, etc.), desktop computer, work station, among other things.

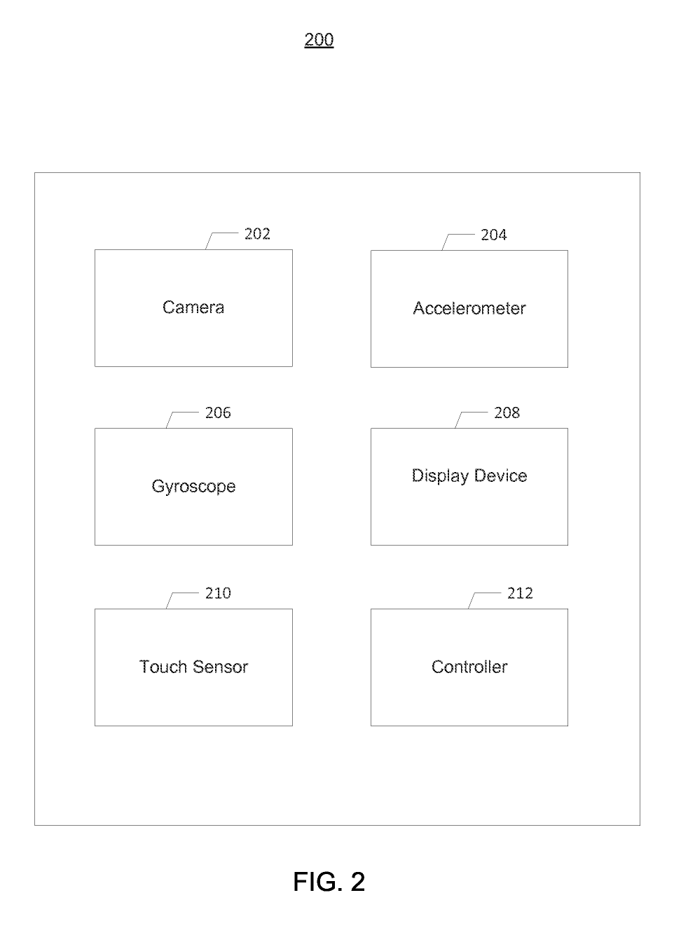

FIG. 2 shows a schematic block diagram of an example mobile device 200, in accordance with some embodiments. Mobile device 200 may include some or all of a motion detection device (e.g., camera 202 and/or accelerometer 204), gyroscope 206, display device 208, touch sensor 210 and controller 212. In some embodiments, camera 202 may be mechanically attached to mobile device 200 with the lens facing in the direction of display device 208 (e.g., the front of mobile device 200). Camera 202 may be configured to generate motion data including images of the user. Here, the user may secure mobile device 200 (e.g., to an exercise machine) such that display device 208 and camera 202 face the user. In some embodiments, the motion detection device may include one or more include one or more of passive infrared (PIR), ultrasonic, microwave and/or tomographic motion detectors configured to generate the motion data alternatively or additionally to camera 202.

Accelerometer 204 may be mechanically attached with mobile device 200, such as within a housing or other exterior portion of mobile device 200. Accelerometer 204 may be configured to generate motion data that include one or more magnitude values. For example, where accelerometer 204 is a three-axis accelerometer, accelerometer 204 may be configured to generate motion data that includes an X axis magnitude value, a Y axis magnitude value, and a Z axis magnitude of (e.g., proper) acceleration. As discussed above and in further detail below, whether the motion data generated by the motion detection device is generated by camera 202, accelerometer 204, and/or other detector, controller 212 may be configured to determine actiplacement scores based on the motion data and update views of a virtual environment based on the actiplacement scores.

In some embodiments, controller 212 may be configured to perform calibrations that allow flexible detection of actiplacement scores based on the nature of the user's physical activity (e.g., whether the mobile device is operating in the handheld or workout mode) as detected by the one or more motion detection devices. For example, controller 212 may be configured to execute a calibration (e.g., prior to each session, upon selection of a different game/application, in response to user input, in response to programmatically detecting a bad calibration, etc.) that maps user motion data with received calibration data indicating one or more user motion data values each associated with different intensity levels of user movement; and adjust a programmatic relationship between the actiplacement score and the user motion data based on the calibration data.

Gyroscope 206 may be configured to generate orientation data indicating an orientation of mobile device 200. Here, controller 212 may be configured to determine, based on the orientation data, a second view of the virtual environment defining a second forward direction. Controller 212 may be further configured to rotate the view of the virtual environment to the second view, such as by an amount corresponding with the amount of change in the orientation of the mobile device by the user. Here, the user may hold mobile device 200 in the user's hand(s) and freely orient the mobile device 200, with reorientations of mobile device 200 being reflected (e.g., in real time) within the subsequent (e.g., rotated) views of the virtual environment. In some embodiments, some or all of the orientation data may alternatively or additionally be determined based on user inputs, such as touch inputs generated by touch sensor 210 and/or other user input device. Furthermore, touch inputs from touch sensor 210 may provide additional user interactions with applications on mobile device 200.

Display Device 208 may be configured to provide interactive displays, such as the graphical interfaces including views of virtual environments discussed herein. In some embodiments, controller 212 may be configured to update the view of the virtual environment in the graphical interface provided to display device 208, such as based on the actiplacement scores and/or among other things (e.g. orientation data, touch inputs, voice inputs, etc.).

In some embodiments, camera 202, accelerometer 204, gyroscope 206, display device 208, touch sensor 210, and controller 212 may each be integrated within or otherwise mechanically attached with each other (e.g., via a housing of mobile device 200). Alternatively, in some embodiments, one or more of camera 202, accelerometer 204, gyroscope 206, display device 208, touch sensor 210, and controller 212 may be separate from mobile device 200. For example, a motion detection device (e.g., camera 202) may be communicatively connected with controller 212 via network 104, wireless connection (e.g., Bluetooth, WiFi, near field communication (NFC), etc.), and/or wired connection (e.g., universal serial bus (USB), pin connector, Ethernet connector, audio jack connector, etc.).

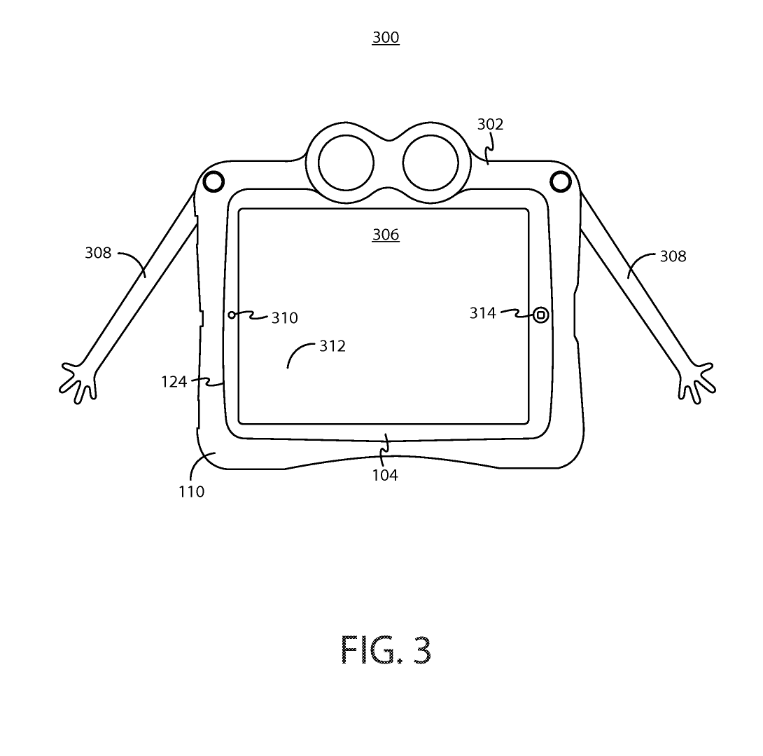

FIG. 3 shows example mobile device holder 300, in accordance with some embodiments. Mobile device holder 300 may include body portion 302 and one or more (e.g., 2) extension arms 304 attached to body portion 302. Body portion 102 may be shaped to hold a mobile device, such as mobile device 306 which is shown in FIG. 3 as a tablet including camera 310, touchscreen 312, and input button 314. As discussed above, in some embodiments, a mobile device may be configured to operate in a workout mode where the mobile device can be secured to an exercise machine or other object. In some embodiments, the mobile device may be secured via extension arms 304 that can freely bend, twist, straighten, among other things into rigid configurations capable of supporting the weight of mobile device holder 300 and/or mobile device 306.

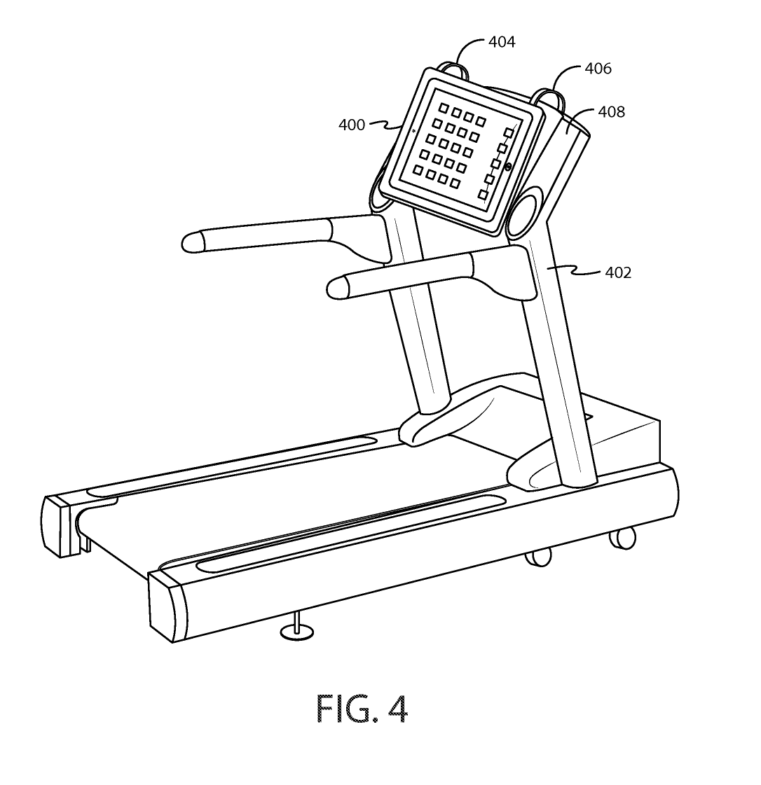

With respect to exercise applications or games, mobile device holder 300 may be leveraged to allow the user to carry mobile device 306 to a fitness facility and secure mobile device 306 to a variety of different exercise machines. FIG. 4 shows a mobile device 400 mounted to an exercise machine 402, in accordance with some embodiments. Extension arms 404 and 406 may be bent into the configuration shown such that extension arms 404 and 406 wrap over the top of panel/monitor 408 of exercise machine 402 to support the weight of mobile device 400 and/or keep mobile device 400 held securely in place. As such, supporting at least the portion of the weight of the mobile device holder with the extension arm in the rigid configuration may include bending the extension arm around at least a portion of an object, such as the top/back of panel/monitor 408 as shown for extension arms 404 and 406. Additional details regarding example mobile device holders, applicable to some embodiments, are discussed in U.S. patent application Ser. No. ______, titled “Mobile Device Holder with Pliable Extension Arms,” which is incorporated by reference herein in its entirety.

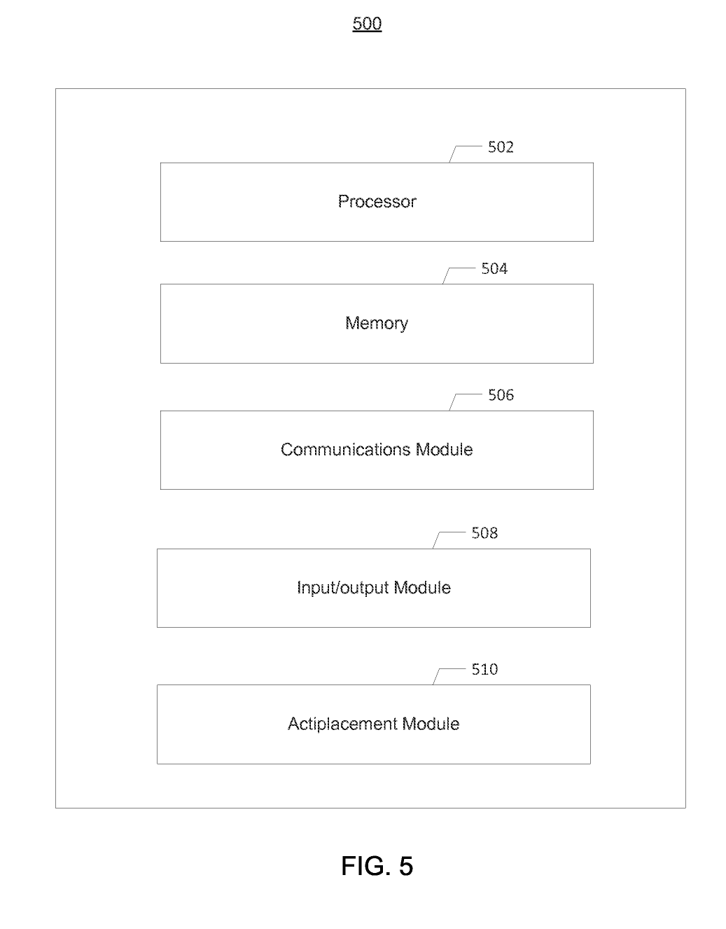

FIG. 5 shows a schematic block diagram of example circuitry 500, some or all of which may be included in mobile device 106 (and/or other (e.g., stationary, exercise machine-integrated, etc.) user device), system 102, server 108, and/or database 110. In accordance with some example embodiments, circuitry 500 may include various means, such as one or more processors 502, memories 504, communications modules 506, and/or input/output modules 508.

In some embodiments, such as when circuitry 500 is included in mobile device 106 and/or system 102, actiplacement module 510 may also or instead be included. As referred to herein, “module” includes hardware, software and/or firmware configured to perform one or more particular functions. In this regard, the means of circuitry 500 as described herein may be embodied as, for example, circuitry, hardware elements (e.g., a suitably programmed processor, combinational logic circuit, integrated circuit, and/or the like), a computer program product comprising computer-readable program instructions stored on a non-transitory computer-readable medium (e.g., memory 504) that is executable by a suitably configured processing device (e.g., processor 502), or some combination thereof.

Processor 502 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 5 as a single processor, in some embodiments, processor 502 may comprise a plurality of processing means. The plurality of processing means may be embodied on a single computing device or may be distributed across a plurality of computing devices collectively configured to function as circuitry 500. The plurality of processing means may be in operative communication with each other and may be collectively configured to perform one or more functionalities of circuitry 500 as described herein. In an example embodiment, processor 502 may be configured to execute instructions stored in memory 504 or otherwise accessible to processor 502. These instructions, when executed by processor 502, may cause circuitry 500 to perform one or more of the functionalities described herein.

Whether configured by hardware, firmware/software methods, or by a combination thereof, processor 502 may comprise an entity capable of performing operations according to embodiments of the present invention while configured accordingly. Thus, for example, when processor 502 is embodied as an ASIC, FPGA or the like, processor 502 may comprise specifically configured hardware for conducting one or more operations described herein. As another example, when processor 502 may be embodied as an executor of instructions, such as may be stored in memory 504, the instructions may specifically configure processor 502 to perform one or more algorithms, methods or operations described herein. For example, processor 502 may be configured to execute operating system applications, firmware applications, media playback applications, media editing applications, among other things.

Memory 504 may comprise, for example, volatile memory, non-volatile memory, or some combination thereof. Although illustrated in FIG. 2 as a single memory, memory 504 may comprise a plurality of memory components. The plurality of memory components may be embodied on a single computing component or distributed across a plurality of computing components. In various embodiments, memory 504 may comprise, for example, a hard disk, random access memory, cache memory, flash memory, a compact disc read only memory (CD-ROM), solid state memory, digital versatile disc read only memory (DVD-ROM), an optical disc, circuitry configured to store information, integrated circuitry, chemical/biological memory, paper, or some combination thereof. Memory 504 may be configured to store information, data, applications, instructions, or the like for enabling circuitry 500 to carry out various functions in accordance with example embodiments discussed herein. For example, in at least some embodiments, memory 504 may be configured to buffer input data for processing by processor 502. Additionally or alternatively, in at least some embodiments, memory 504 may be configured to store program instructions for execution by processor 502 and/or data for processing by processor 502. Memory 504 may store information in the form of static and/or dynamic information. This stored information may be stored and/or used by circuitry 500 during the course of performing its functionalities.

Communications module 506 may be embodied as any component or means embodied in circuitry, hardware, a computer program product comprising computer readable program instructions stored on a computer readable medium (e.g., memory 504) and executed by a processing device (e.g., processor 502), or a combination thereof that is configured to receive and/or transmit data from/to another device, such as, for example, a second circuitry 500 and/or the like. In some embodiments, communications module 506 (like other components discussed herein) can be at least partially embodied as or otherwise controlled by processor 502. In this regard, communications module 506 may be in communication with processor 502, such as via a bus. Communications module 506 may include, for example, an antenna, a transmitter, a receiver, a transceiver, network interface card and/or supporting hardware and/or firmware/software for enabling communications. Communications module 506 may be configured to receive and/or transmit any data that may be stored by memory 504 using any protocol that may be used for communications. Communications module 506 may additionally and/or alternatively be in communication with the memory 504, input/output module 508 and/or any other component of circuitry 500, such as via a bus. Communications module 506 may be configured to use one or more communications protocols such as, for example, Wi-Fi (e.g., a 802.11 protocol, etc.), Bluetooth, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

Input/output module 508 may be in communication with processor 502 to receive an indication of an input and/or to provide an audible, visual, mechanical, or other output. Some example inputs discussed herein may include user motion data generated by a motion detection device such as a camera and/or accelerometer, orientation data generated by a gyroscope or touch sensor, calibration data, etc. In that sense, input/output module 508 may include means for performing analog-to-digital and/or digital-to-analog data conversions. Input/output module 208 may include support, for example, for a camera, accelerometer, gyroscope, other motion detection device, display device, touch sensor, touch screen, keyboard, button, click wheel, mouse, joystick, an image capturing device, microphone, speaker, biometric scanner, heart monitor, and/or other input/output mechanisms. In embodiments where circuitry 500 may be implemented as a server or database, aspects of input/output module 508 may be reduced as compared to embodiments where circuitry 500 may be implemented as an end-user machine or other type of device designed for complex user interactions. In some embodiments (like other components discussed herein), input/output module 508 may even be eliminated from circuitry 500. Alternatively, such as in embodiments wherein circuitry 500 is embodied as a server or database, at least some aspects of input/output module 508 may be embodied on a mobile device used by a user that is in communication with circuitry 500. Input/output module 508 may be in communication with memory 504, communications module 506, and/or any other component(s), such as via a bus. Although more than one input/output module and/or other component can be included in circuitry 500, only one is shown in FIG. 5 to avoid overcomplicating the disclosure (e.g., like the other components discussed herein).

In some embodiments, actiplacement module 510 may also or instead be included and configured to perform the functionality discussed herein related providing user motion controlled virtual environment interaction. In some embodiments, some or all of the functionality of actiplacement module 510 may be performed by processor 502. In this regard, the example processes and algorithms discussed herein can be performed by at least one processor 502 and/or actiplacement module 510. For example, non-transitory computer readable storage media can be configured to store firmware, one or more application programs, and/or other software, which include instructions and other computer-readable program code portions that can be executed to control processors of the components of system 500 to implement various operations, including the examples shown above. As such, a series of computer-readable program code portions may be embodied in one or more computer program products and can be used, with a device, server, database, and/or other programmable apparatus, to produce the machine-implemented processes discussed herein.

Any such computer program instructions and/or other type of code may be loaded onto a computer, processor or other programmable apparatus's circuitry to produce a machine, such that the computer, processor other programmable circuitry that executes the code may be the means for implementing various functions, including those described herein. In some embodiments, one or more external systems (such as a remote cloud computing and/or data storage system) may also be leveraged to provide at least some of the functionality discussed herein.

As described above and as will be appreciated based on this disclosure, various embodiments may be implemented as methods, mediums, devices, servers, databases, systems, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD/DVD-ROMs, flash memory, optical storage devices, quantum storage devices, chemical storage devices, biological storage devices, magnetic storage devices, etc.

Embodiments have been described above with reference to block diagrams of components, such as functional modules, system components and circuitry. Below is a discussion of an example process flowcharts describing functionality that may be implemented by one or more components discussed above. Each block of the block diagrams and process flowcharts, and combinations of blocks diagrams and process flowcharts, respectively, can be implemented by various means including computer program instructions. These computer program instructions may be loaded onto a general purpose computer, special purpose computer, or other programmable data processing apparatus, such as processor 502, to produce a machine, such that the computer program product includes the instructions which execute on the computer or other programmable data processing apparatus to create a means for implementing the functions specified in the flowchart block or block diagrams.

These computer program instructions may also be stored in a computer-readable storage device (e.g., memory 504) that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the block diagrams and process flowcharts, and combinations of blocks in the block diagrams and process flowcharts, can be implemented by special purpose hardware-based computer systems that perform the specified functions or steps, or combinations of special purpose hardware and computer instructions.

### Motion Controlled Virtual Environment Interaction

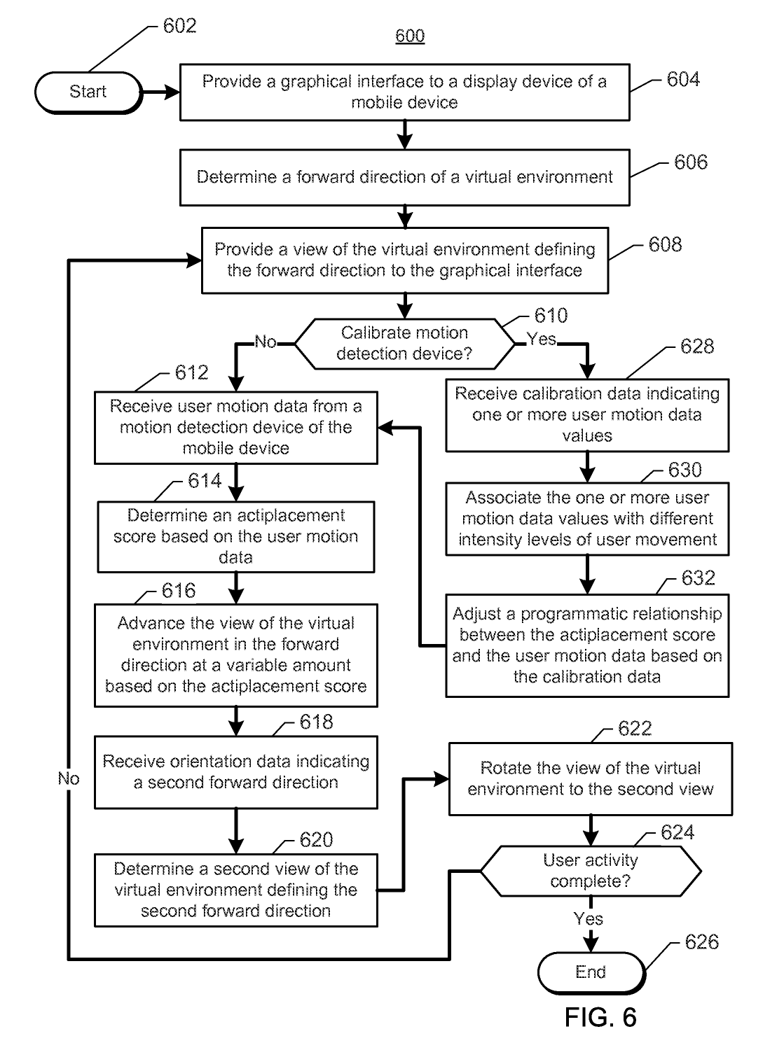

FIGS. 6-8 show flowcharts of example methods 600-800, respectively, in accordance with some embodiments. Most of the steps of methods 600-800 are discussed herein as being performed by a mobile device, such as mobile device 106 or 200. However, other suitable devices, apparatus, systems and/or circuitry may be used. For example, in some embodiments where the mobile device is a thin client, system 102 including server 108 and database 110 may be configured to perform some or all of the functionality discussed herein for the mobile device.

FIG. 6 shows a flowchart of an example of a method 600 for providing motion controlled virtual environment interaction, in accordance with some embodiments. Method 600 may begin at 602 and proceed to 604, where a mobile device may be configured to provide a graphical interface to a display device. For example, the circuitry and/or controller 212 of mobile device 200 may be configured to provide the graphical interface to display device 208. In some embodiments, the graphical interface may be provided as part of an exercise game and/or application executing on the mobile device.

At 606, mobile device 200 may be configured to determine a forward direction of a virtual environment that defines a view of the virtual environment. In some embodiments, the graphical interface may include views of a virtual environment. For example, the virtual environment may be represented by images and/or video of rendered 3D computer graphics. The virtual environment may include a location, map, roadway(s), room(s), landscape, among other things that may vary depending on the application and/or game being provided by the mobile device.

In some embodiments, a view of a virtual environment may define and/or be defined by the forward direction. For example and as discussed above, the forward direction may refer to the direction the user and/or an avatar of the user is “facing” in the virtual environment as defined by the view of the virtual environment in the graphical interface.

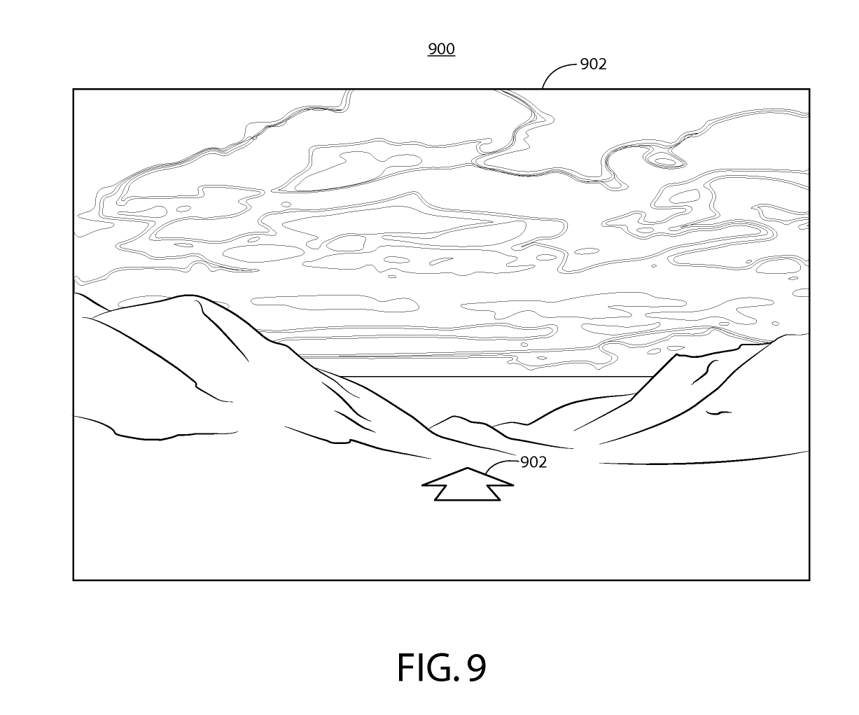

At 608, mobile device 200 may be configured to provide a view of the virtual environment defining the forward direction to the graphical interface. FIG. 9 shows an example graphical interface 900 including a first person view 900 of a virtual environment, in accordance with some embodiments. View 900 may include virtual environment 902 shown as an outdoor landscape and may define a forward direction in the pointing direction of arrow 902.

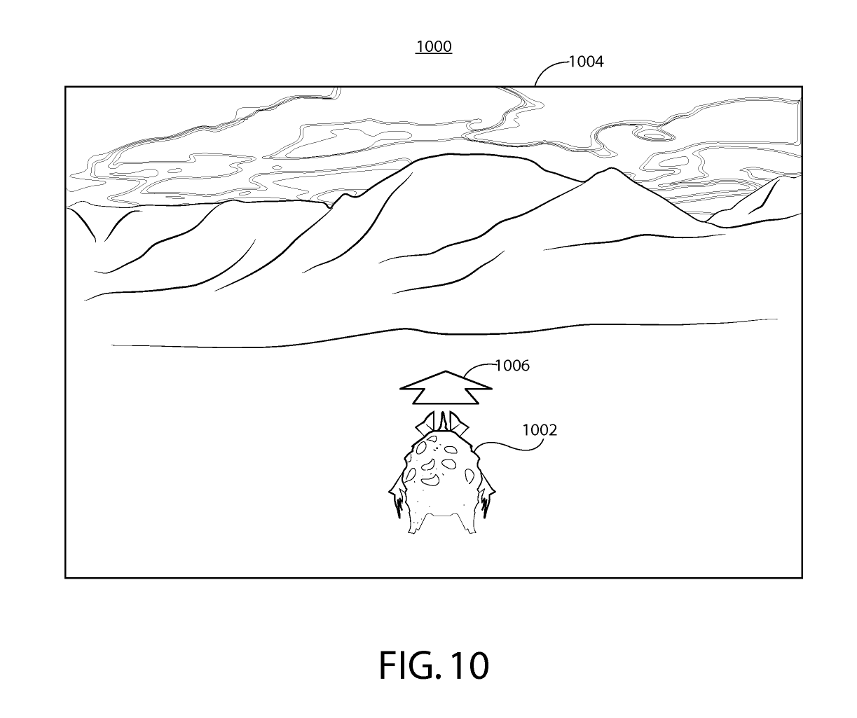

FIG. 10 shows an example graphical interface 1000 including a third person view 1000 of a virtual environment, in accordance with some embodiments. View 1000 may include avatar 1002, shown here is a monster character, and virtual environment 1004, shown as an outdoor landscape. View 1000 and/or avatar 1002 may define the forward direction the third person view. For example, the forward direction may be based on the facing direction of avatar 1002, as shown by the pointing direction of arrow 1006.

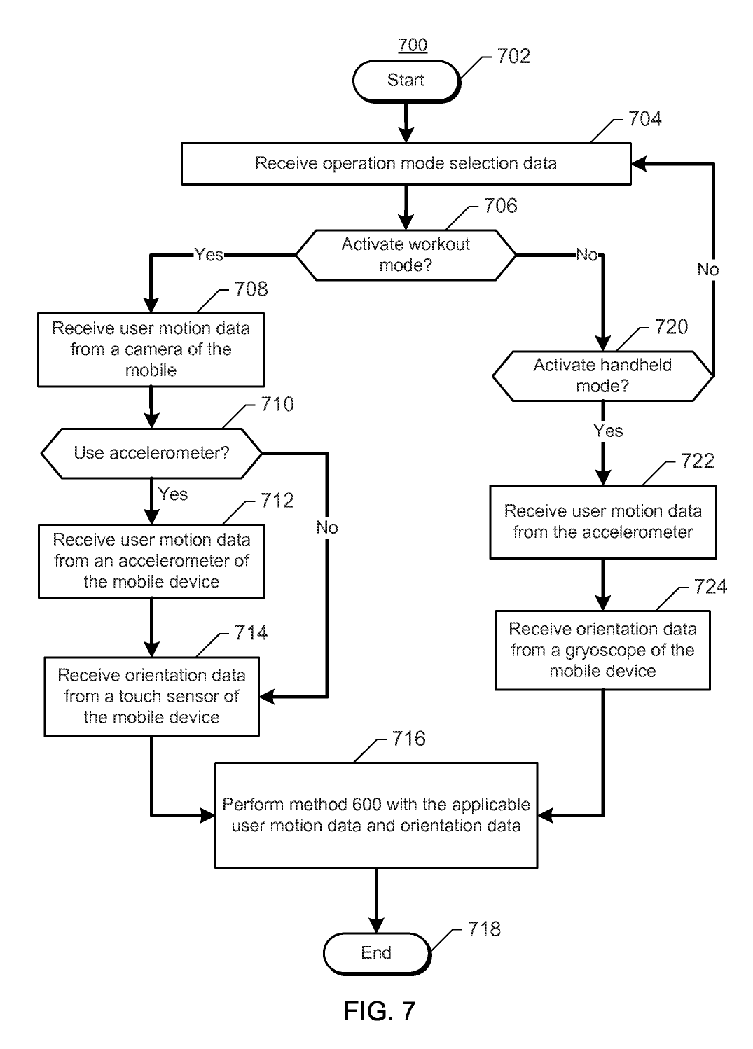

At 610, mobile device 200 may be configured to determine whether to calibrate a motion detection device. As discussed in further detail below with respect to method 700 shown in FIG. 7, in some embodiments, different motion detection devices may be used to capture relevant user motion data depending on a mode of operation of the mobile device and/or various exercise applications. Some example motion detection devices may include a camera and/or accelerometer.

The calibration of the motion detection devices allows for flexibility in associating different values and/or characteristics of user motion data with different user motion intensities levels and/or actiplacement scores. For example, user motion data captured by camera 202 (e.g., as may be used in a workout mode where the mobile device 200/400 is mounted to an exercise machine as shown in FIG. 4), may vary for equivalent levels of user motion intensity depending on factors such as the type of exercise machine being used (e.g., the camera may capture more user “bounce” when the user is running on a treadmill rather than riding on a stationary bike), the precise location of the mobile device/camera relative to the user, differences in movement for different users, etc.

In some embodiments, mobile device 200 may be configured to calibrate one or more motion detection devices at the beginning of an exercise game and/or application session and/or upon user request. For example, prior to providing the view of the virtual environment at 608, mobile device 200 may be configured to provide an interface for calibration to the graphical interface to perform the calibration.

Additionally or alternatively, mobile device 200 may be configured to adjust a previous calibration or otherwise recalibrate the one or more motion detection devices, such as upon programmatically recognizing a calibration error. Mobile device 200 may be configured to monitor determined actiplacement scores based on live user motion data against the user's historical actiplacement scores to determine values relative to a predetermined threshold that may trigger a recalibration. The predetermined threshold may, for example, may be set to the user's maximum pace such that actiplacement scores can be scaled down when live user motion data values indicate that the user is capable of performing at a higher intensity than that of the calibrated maximum pace.

In response to determining to not calibrate a motion detection device, method 600 may proceed to 610, where mobile device 200 may be configured to receive user motion data from a motion detection device of mobile device 200. Here, the mobile device may be configured to execute processes for allowing free world exploration of the virtual environment and/or other user interactions. In some embodiments, the user motion data may be received from camera 202 and/or accelerometer 204, such as depending on the mode of operation and/or exercise application being executed.

In some embodiments, such as when the user motion data is received from a camera, the user motion data may include images captured by the camera, such as of the user (e.g., and the user's surrounding or background) over time while the user is performing exercise or other motion.

Alternatively or additionally, such as when the user motion data is received from a three axis accelerometer, the user motion data may include an X axis magnitude value, a Y axis magnitude value, and a Z axis magnitude value. A set of X axis magnitude value, Y axis magnitude value and Z axis magnitude values may each represent an acceleration captured in a respective direction in a measurement cycle (e.g., or an average or other sampling of multiple cycles) of the accelerometer.

At 614, mobile device 200 may be configured to determine an actiplacement score based on the user motion data. As discussed above, the actiplacement score may include or define a numeric value, magnitude, etc. that provides an indication of an intensity level of user movement within a period of time period. In some embodiments, mobile device may be configured to determine the actiplacement score based on the user motion data by accessing and/or otherwise determining a programmatic relationship between the user motion data and the actiplacement score. For example, and as discussed at 628-632 below, mobile device 200 may be configured to determine the programmatic relationship based on performing a calibration.

In some embodiments, such as when the user motion data is received from the camera, mobile device 200 may be configured to determine the actiplacement score based at least in part on detecting differences between images captured over time. For example, mobile device 200 may be configured to programmatically compare a first image and a second image, where the first image is generated by the camera before the second image. For example, the first image may be in a sequence of images with the second image captured over time (e.g., while free world exploration of the virtual environment is being provided). Mobile device 200 may be configured to recognize a shape of the user in each of the first image and the second image (e.g., as opposed to objects associated with the background and/or background objects), determine a difference in the shape, and based on the timing of when the first image and the second image where generated by the camera, determine a camera movement intensity score. Similarly, multiple images may be captured and compared to determine the actiplacement score within the time in which the multiple images were captured. Mobile device 200 may be further configured to determine the actiplacement score based on the camera movement intensity score, such as by weighting the camera movement score by one or more factor values determined based on the calibration data. In another example, a factor value may be based on a difficulty setting (e.g., configurable by the user), such that greater (e.g., for a harder setting) or smaller (e.g. for an easier setting) intensities of user movement are needed for a corresponding increase in the actiplacement score.

In some embodiments, such as when the user motion data is received from the accelerometer, mobile device 200 may be configured to determine the actiplacement score based at least in part on one or more of the X axis, Y axis, and Z axis magnitude values of a set of three axis magnitude values. In some embodiments, a single or two of the three axis magnitude value may be used. In some embodiments, mobile device 200 may be configured to determine an axis magnitude score based on the X axis, Y axis and Z axis magnitude values, such as by taking the square root of the sums of the square values of the X axis, Y axis and Z axis magnitude values. In some embodiments, the accelerometer may include a single axis or two axis accelerometer. Here, mobile device 200 may be configured to determine the axis magnitude score as the single axis magnitude value (e.g., for a single axis accelerometer) or as the square root of the sums of the squares of the two axis magnitude values (e.g., for a two axis accelerometer).

At 616, mobile device 200 may be configured to advance the view of the virtual environment in the forward direction at a variable amount based on the actiplacement score. Here, the user may traverse the virtual environment (e.g., in first person view or in third person view with an avatar) at a rate that is associated with the intensity level of user motion as defined by the actiplacement score. The amount of user traversal may be based on the actiplacement score, defining a rate of travel, as well as the applicable period of time during which the actiplacement score was captured. In some embodiments, the actiplacement score may define the amount of user traversal (e.g., rather than or in addition to the rate of travel).

In some embodiments, the amount of advancement of the view or user traversal associated with a particular actiplacement score may depend on the exercise application or virtual environment. For example, the view may be advanced further for a game where the user's real world motion is used to “power” a vehicle than a game where the user's real world motion is used to power a slower object, such as a human-like avatar running with legs.

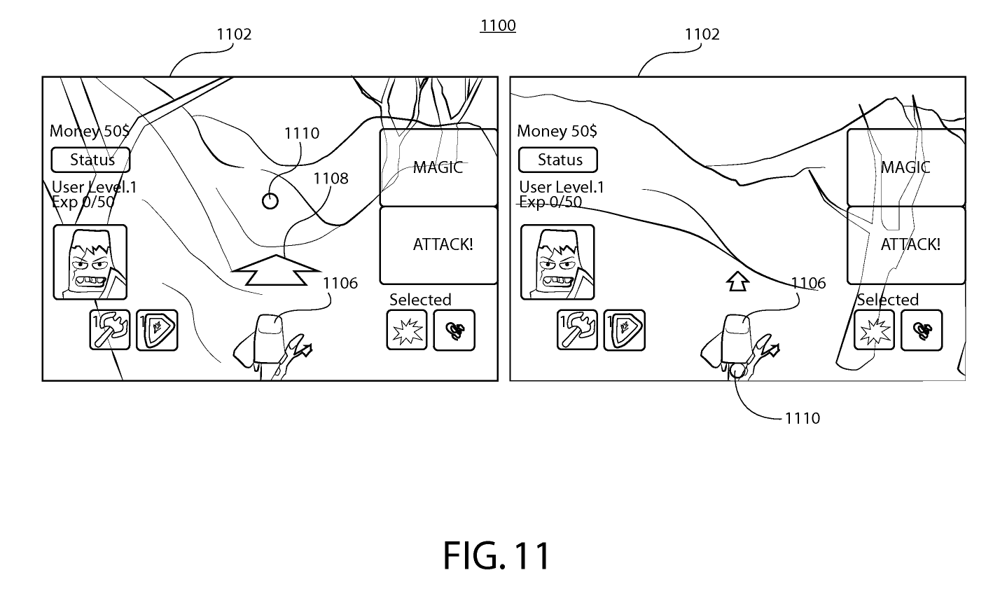

FIG. 11 shows two views 1102 and 1104 of an example graphical interface 1000, in accordance with some embodiments. Views 1102 and 1104 show forward motion of avatar 1106 through the same virtual environment. View 1102 and/or avatar 1106 may define a forward direction shown by arrow 1108 that points to location 1110. Based on the actiplacement score, the view of the virtual environment may be advanced a variable amount in the forward direction as shown in view 1104. Here, avatar 1106 is shown as being at location 1110 subsequent to traversal at the variable rate.

At 618, mobile device 200 may be configured to receive orientation data indicating a second forward direction. The orientation data, as discussed above, may include orientation data received from a gyroscope and/or user input data received from a user input device, such as a touch sensor. In some embodiments, mobile device 200 may be configured to receive the orientation data from gyroscope 206 of mobile device 200. For example, gyroscope 206 may be used when mobile device 200 is operating in the handheld mode or otherwise executing an application and/or exercise game played with mobile device 200 is being held in the user's hands. In some embodiments, mobile device 200 may be configured to receive the orientation data from touch sensor 210 and/or other user input device (e.g., button, keypad, touchpad, keyboard, mouse, microphone, etc.). For example, touch sensor 210 may be used when mobile device 200 is operating in the workout mode or otherwise executing an application and/or exercise game played with mobile device 200 being secured to an exercise machine or object (e.g., not held in the user's), such as where the orientation of mobile device 200 (e.g., as measured by the gyroscope) does not change in accordance with user motion.

At 620, mobile device 200 may be configured to determine and/or generate a second view of the virtual environment defining the second forward direction. For example, different values of the orientation data may be associated with different forward directions, which may be further used to determine and/or generate the corresponding views of the virtual environment.

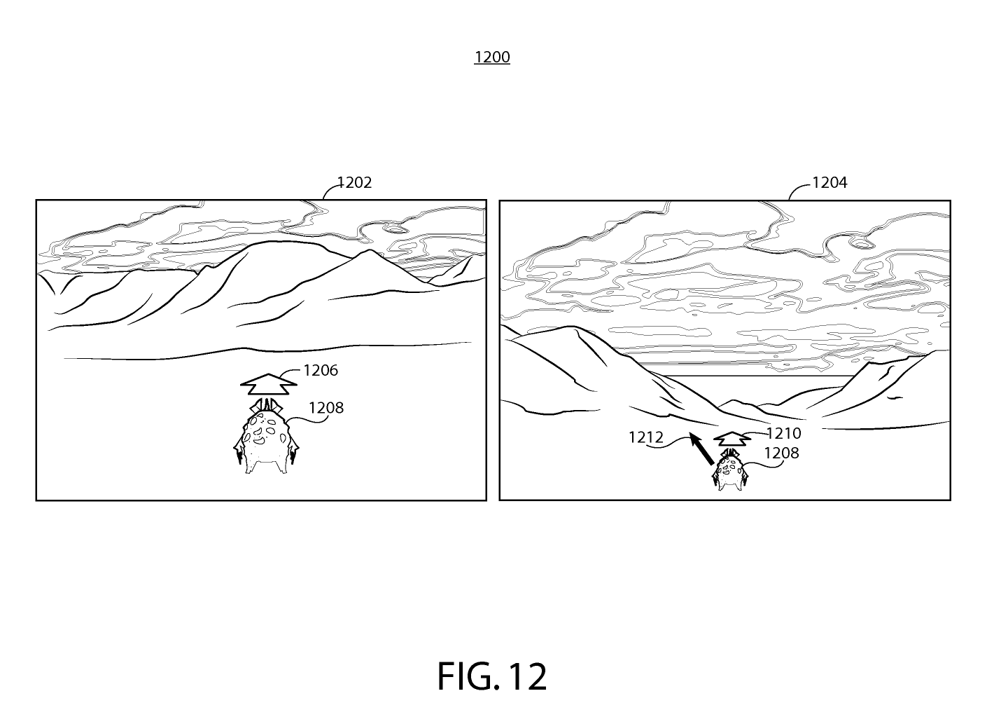

At 622, mobile device 200 may be configured to rotate the view of the virtual environment to the second view of the virtual environment. FIG. 12 shows two views 1202 and 1204 of an example graphical interface 1200, in accordance with some embodiments. Views 1202 and 1204 show rotation of views through the same virtual environment. View 1202 and/or avatar 1206 may define a first forward direction as shown by arrow 1206. Via received orientation data, view 1202 may be rotated as shown in view 1204. View 1202 and/or avatar 1208 (which may be the same as avatar 1208 shown in view 1202) may define a second forward direction as shown by arrow 1210. Arrow 1212 is also shown to illustrate the original forward direction shown by arrow 1206 in view 1202. Relative to view 1202, view 1204 has been rotated to the right by approximately 15 degrees. Views within a graphical interface may be rotated in any direction by the user including left/right and/or top/bottom directions (e.g., depending on the application and/or game context).

Mobile device 200 may be configured to allow the user to freely change the forward direction and corresponding view of the virtual environment by providing various orientation data, such as by changing the orientation of the mobile device and/or by providing user inputs via the touch sensor. As such, the user is provided with free world exploration where the user may move in a forward direction at variable rates based on user motion data and change forward directions variable amounts based on orientation data, among other user interactions that may be possible.

At 624, mobile device 200 may be configured to determine whether user activity has been completed. For example, the graphical interface may be provided in connection with an exercise game that may include various objectives or requirements that must be fulfilled by the user. For example, in an exercise game, the user may be asked to perform continuous physical motion that may be detected as user motion data to navigate the user and/or avatar of the user through the virtual environment. In a quest game, for example, the user may be tasked with racing (e.g., against others, the user's recorded performances, etc.) around the virtual environment to find and collect items (e.g., pieces of a magic key) while avoiding non-player controlled monsters and/or other competing players. In cart racing game, for example, the user may be tasked with crossing a finish line in a cart race around a virtual environment (e.g., a race track). Here, the user may be allowed to select an avatar and/or vehicle that may be powered by the detected motion. In another example of a dancing game, the user may be tasked with performing a particular set of movements, such as to match a historical set of moves of another user and/or as directed by the graphical interface. In some embodiments, mobile device 200 may be configured to determine that user activity has been completed upon completion of the game (e.g., completion or fatal failure of one or more objectives), based on user input, among other things. In some embodiments, mobile device 200 may be configured to determine that the user activity has been completed based on receiving user motion data indicating that the user has stopped moving, such as when continuous movement is an objective of an exercise game.

In response to determining that the user activity has completed, method 600 may proceed to 626 and end. In response to determining that the user activity has failed to be completed, method 600 may return to 608, where mobile device 200 may be configured to continue providing views of the virtual environment. Furthermore, mobile device 200 may be configured to continue adjusting (e.g., advancing and/or rotating) the views based on the user motion data and/or orientation data received by control circuitry of mobile, such as until the user activity has been determined to be completed.

Returning to 610, in response to determining to calibrate one or more motion detection devices (e.g., for initial calibration and/or subsequent recalibration), method 600 may proceed to 628, where mobile device 200 may be configured to receive calibration data indicating one or more user motion data values.

At 630, mobile device 200 may be configured to associate the one or more user motion data values with different intensity levels of user movement. The calibration data may include different user motion data values captured in response to prompting the user to perform an exercise and/or motion (e.g., running a treadmill, riding an exercise bike, etc.) at varying levels of intensity. For example, for a treadmill, the user may be asked to walk/run for 60 seconds at randomly ordered speeds, such as at to run at maximum pace for 15 seconds, to run at moderate pace for 15 seconds, to walk at a normal pace for 15 seconds, then to run at the maximum pace for 15 seconds.

At 632, mobile device 200 may be configured to adjust the programmatic relationship between antiplacement scores and the user motion data based on the calibration data. For example, mobile device 200 may be configured to determine a factor value or the like to the user motion data (e.g., the determined camera movement intensity score and/or the axis magnitude score discussed above at 614) to determine antiplacement scores based on subsequently received user data. Method 600 may then return to 612, as discussed above. For example, mobile device 200 may be configured to determine actiplacement scores at 614 based on the calibrated user data.

FIG. 7 shows a flowchart of an example of a method 700 for facilitating multiple modes of user motion detection, in accordance with some embodiments. As discussed above, mobile device 200 may be configured to operate in various operation modes that may utilize different types of user motion data and/or orientation data. In some embodiments, the various operation modes may be provided to offer flexibility in the type of user motions or exercise movements that can be detected by the mobile device to drive virtual world motion for a variety of different games that make exercise more fun, competitive, social and/or interesting.

Method 700 may begin at 702 and proceed to 704, where mobile device 200 may be configured to receive operation mode selection data. For example, mobile device 200 may be configured to provide an operation mode selection display to the graphical interface including one or more selectable buttons that each represents a different operation mode (e.g., handheld mode or workout mode) and/or game (e.g., with a game associated with one or more operation modes). The user may generate the operation mode selection data, such as by selecting a suitable button on the operation mode selection display via touch sensor 210 and/or other user input device. In some embodiments, the operation modes indicated by the operation mode selection data may include a workout mode and/or a handheld mode.

At 706, mobile device 200 may be configured to determine whether to activate the workout mode. For example, the determination may be based on the operation mode selection data. As discussed above, in the workout mode, mobile device 200 may be mounted to an exercise machine, fitness equipment or other (e.g., non-user) object.

In response to determining to activate the workout mode, method 700 may proceed to 708, where mobile device 200 may be configured to receive user motion data from a camera of the motion device. For example, in the workout mode, the camera may be configured to capture images of the user as the user motion data. Mobile device 200 may be configured to activate the camera and/or otherwise initiate the generation of user motion data by the camera.

At 710, mobile device 200 may be configured to determine whether the use an accelerometer for the workout mode. In some embodiments, such as when mobile device 200 is secured to an exercise machine, the accelerometer may be configured to detect vibrations of the exercise machine caused by user movement as additional or alternative user motion data. For example, mobile device 200 may be configured to use one or more of the user motion data captured from the camera and accelerometer. In some embodiments, when user motion data from the camera and accelerometer are used, actiplacement scores may be calculated for user motion data from each source. Mobile device 200 may be further configured to determine an average actiplacement score based on two or more (e.g., weighted or otherwise) actiplacement scores and/or select one of a plurality of actiplacement scores. Based on the determined and/or selected actiplacement score, mobile device 200 may be configured to advance views of a virtual environment accordingly.

In some embodiments, mobile device 200 may be configured to perform a calibration to determine whether to activate the camera, accelerometer, or both. Depending on various factors such as the location of the mobile device camera relative to the user, the type of exercise machine being used, etc., user movement data from one of the camera or accelerometer may be more reliable and/or accurate than the other indicating intensities of user motion. In the calibration discussed at 628-632 of method 600, for example, mobile device 200 may be configured to determine whether the user motion data from the camera or accelerometer more faithfully reflects the differences between the different paces of motion performed by the user during the calibration.

In response to determining to use the accelerometer, method 700 may proceed to 712, where mobile device 200 may be configured to receive user motion data from an accelerometer of the mobile device. For example, mobile device 200 may be configured to activate the accelerometer and/or otherwise initiate the generation of user motion data by the accelerometer.

Method 700 may then proceed to 714. Returning to 710, in response to determining to not use the accelerometer, method 700 may also proceed to 714. At 714, mobile device 200 may be configured to receive orientation data from a touch sensor (and/or other user input device) of the mobile device. In some embodiments, the user may be allowed to provide the orientation data by touching or swiping a side portion of the graphical interface and/or view of the virtual environment. For example, in response to the user touching a swiping leftwards on a left portion of the graphical interface or view, the view of the virtual environment may be rotated a variable amount to the left, such as by an amount that depends on the location, speed and/or duration of the touch or swipe as indicated by the orientation data.

At 716, mobile device 200 may be configured to perform some or all of the method 600 with the applicable user motion data and orientation data for the operation mode. In the workout mode, for example, mobile device 200 may be configured to receive user motion data from the camera and/or accelerometer and orientation data from the touch sensor and/or other user input device.

Returning to 706, in response to determining to not activate the workout mode, method 700 may proceed to 720, where mobile device 200 may be configured to determine whether to activate the handheld mode. In the handheld mode, the user may be allowed to freely rotate and move the mobile device (e.g., in the user's hands), which may cause a corresponding change in the view of the virtual environment.

In response to determining to not activate the handheld mode, method 700 may return to 704, where mobile device 200 may be configured to receive operation mode selection data. In response to determining to activate the handheld mode, method 700 may proceed to 724, where mobile device 200 may be configured to receive user motion data from the accelerometer. For example, mobile device 200 may be configured to activate the accelerometer and/or otherwise initiate the generation of user motion data by the accelerometer.

At 724, mobile device 200 may be configured to receive orientation data from a gyroscope of the motion device. For example, mobile device 200 may be configured to activate the gyroscope and/or otherwise initiate the generation of the orientation data by the gyroscope.

Method 700 may then proceed to 716, where mobile device 200 may be configured to perform some or all of the method 600 with the applicable user motion data and orientation data for the operation mode. In the handheld mode, for example, mobile device 200 may be configured to receive user motion data from the accelerometer and/or and orientation data from the gyroscope in connection. Method 700 may then end at 718.

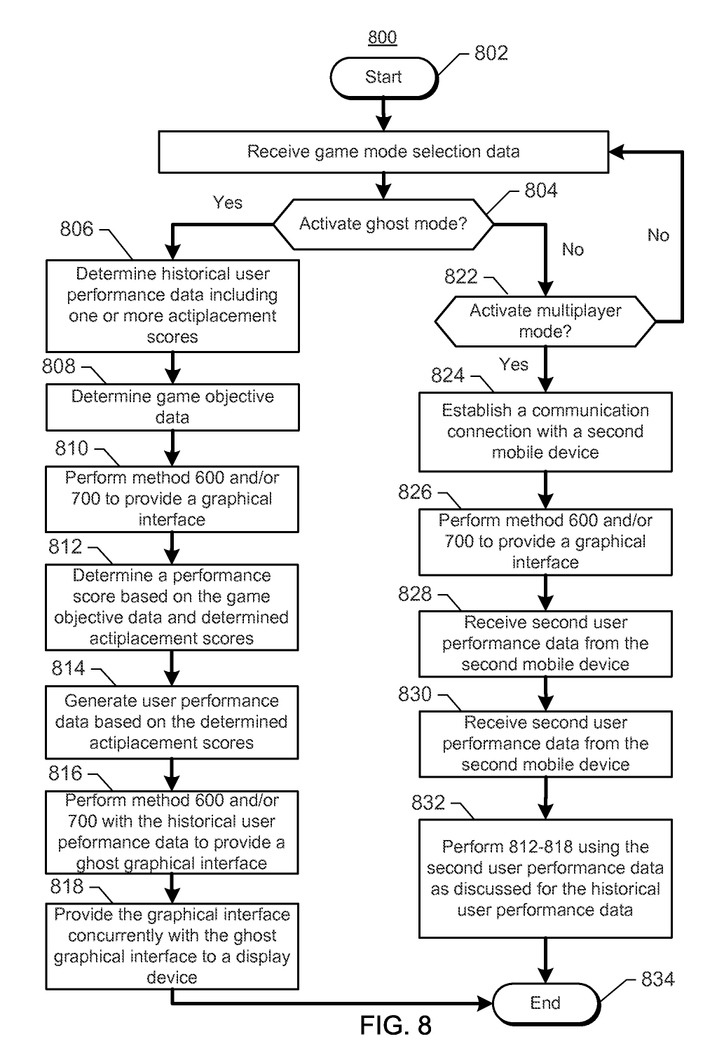

FIG. 8 shows a flowchart of an example of a method 800 for providing an exercise game, in accordance with some embodiments. For example, mobile device 200 may be configured to provide various exercise games, such as racing or racing-style games, capable of being played in connection with one or more game modes. Some of the various possible game modes may provide the user with various competitive gaming options that may further promote exercise, incentivize increased physical performance, and provide entertainment. For example, in a ghost mode, a user may be allowed to play against a previous performance of the user or another user. In another example for a multiplayer mode, the user may be allowed to play an exercise game against other users, such as in real time and at virtually any location via the mobile device.

Method 800 may begin at 802 and proceed to 804, where mobile device 200 may be configured to receive game mode selection data. For example, mobile device 200 may be configured to provide a game mode selection display to the graphical interface including one or more selectable buttons that each represents a different game mode (e.g., handheld mode or workout mode) and/or game (e.g., associated with one or more game modes). In some embodiments, mobile device 200 may be configured to provide a game selection display that may include one or more selectable buttons that each represents a different game. Upon selection of a game, mobile device 200 may be configured to determine the game mode and/or operation mode based on user input (e.g., where options are available) and/or based on predetermined settings for the selected game. In some embodiments, the user may generate the game mode selection data, such as by selecting a suitable button on the game mode selection display via touch sensor 210 and/or other user input device. In some embodiments, the game modes indicated by the game mode selection data may include a ghost mode and a multiplayer mode.

At 804, mobile device 200 may be configured to determine to whether to activate ghost mode. In ghost mode, the user may be allowed to play against a recorded performance, such as in a racing game, of a ghost user. The ghost user may include the user at a prior time (e.g., a recorded performance by the user) and/or one or more other users. In some embodiments, mobile device 200 may determine to activate ghost mode in response to a user input, such as from touch sensor 210 and/or other input device. The user input may further indicate a user selection of a particular recorded performance to play against.

In response to determining to activate ghost mode, method 800 may proceed to 806, where mobile device 200 may be configured to determine historical user performance data. The user performance data may indicate the interactions of a user in a virtual environment. In some embodiments, the historical user performance data may be stored in a memory of mobile device 200 and accessed by processing circuitry of mobile device 200. Alternatively or additionally, the historical user performance data may be stored in the central system 102, such as in database 110. Mobile device 200 may be configured to receive the historical user performance data from central system 102, such as in response to sending a request. The historical user performance data may be that of the user and/or one or more other users.

In some embodiments, user performance data may include a log of events, actions, locations, movements, inputs, performance scores (e.g., as accumulated over time) and/or other interactions performed via the generation of user motion data, orientation data, user input data, etc. in connection with traversing the virtual environment. In some embodiments, the user performance data may include user motion data, orientation data, user input data, etc. captured over time. The user performance data may additionally or alternatively include actiplacement scores, such as a log of recorded actiplacement scores of the user determined by the user motion data.

In some embodiments, central system 102 may be configured to provide a communication hub for mobile devices 200 to share game related data, among other things, with other mobile devices and/or users, such as performance scores and/or game performance data. Central system 102 may further be configured to provide gameplay video highlights, celebration videos (e.g., earned via badges and/or recorded using the camera of the mobile), leader boards, and/or data sharing with social networking systems. In some embodiments, central system 102 may be further configured to provide user progress tracking (e.g., based on performance scores), such as for users, teachers, parents, trainers, coaches, etc. In some embodiments, central system may be further configured to provide for user accounts that may be associated with users and accessed via a mobile device 200. The user accounts may be associated with various data of the user such as user information, profile data, performance scores, historical game performance data, social networking data (e.g., friends, groups, newsfeeds, etc.), among other things. The user accounts may be additionally or alternatively associated with reward tracking points, such that users may earn reward points for completing various games, objectives, training goals, etc. that may be redeemed for prizes.

At 808, mobile device 200 may be configured to determine game objective data. The game objective data may vary based on the game selected by the user. In the quest game discussed above, for example, the user may be tasked with racing around the virtual environment to find and collect items (e.g., pieces of a magic key) while avoiding non-player controlled monsters and/or other competing players. In addition to movement, the player may be allowed to provide user inputs (e.g., via touch sensor 210) that allow for spell casting, weapon attacks, and/or other virtual environment interactions. The game objective data may indicate that players earn points based on finding each of the required items as quickly as possible and/or other predefined virtual environment interactions (e.g., collecting bonus items, slaying monsters, slowing other questers via spells or attacks, etc.). In the cart racing game example, the game objective data may indicate that players may earn points based on crossing the finish line, with the best scores having the fastest time to the finish. Users may also be provided with power ups (e.g., shields, speed increase, invulnerability, etc.) and/or attacks that may slow other racers.

At 810, mobile device 200 may be configured to perform method 600 and/or 700 to provide a graphical interface. As discussed above, the graphical interface may include views of the virtual environment that may be traversed by the user via providing user motion data, orientation data, etc. to the mobile device as discussed herein. For example, mobile device 200 may be configured to determine actiplacement scores based on the user motion data and advance views of the virtual environment variable amounts based on the determined actiplacement scores.

In some embodiments, mobile device 200 may be configured to provide one or more ghost user avatars to the graphical interface. A ghost user avatar may include an avatar previously selected by the ghost user and/or may vary depending on the design, themes, settings, etc. of the exercise game (e.g., a human-like character, vehicle, etc.). Based on the historical user performance data, mobile device 200 may be configured to traverse and/or rotate the ghost avatar within the view of the virtual environment. Here, for example, the user may be allowed to “race” against the ghost user, with the ghost user's historical performance being represented by the ghost avatar within the first graphical interface. In some embodiments, one or more ghost users may be included (e.g., via different sets of historical user performance data processed concurrently) within a game session such that the user can race against the one or more ghost users (e.g., at the same time) within the virtual environment.

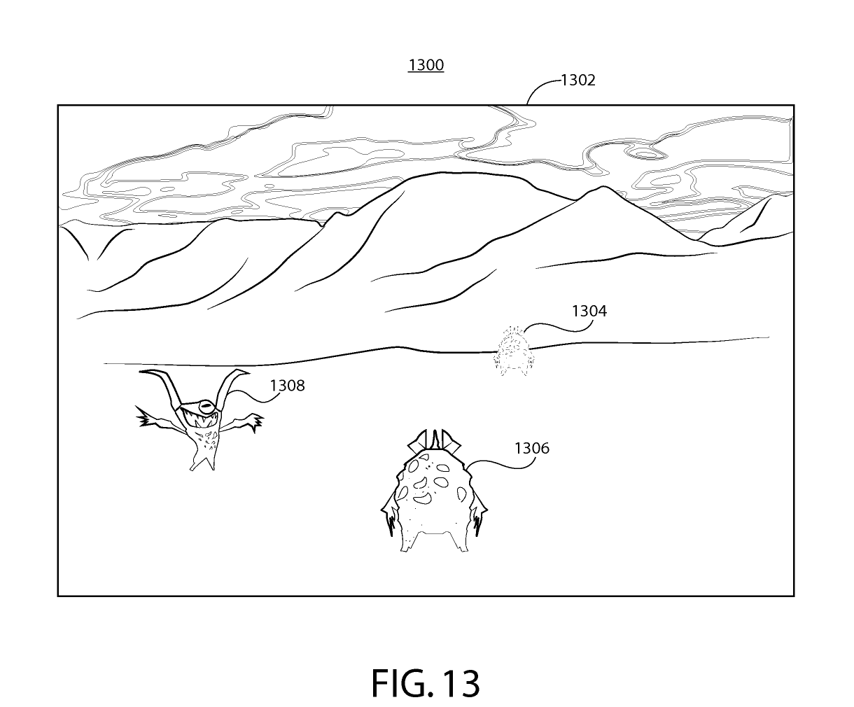

FIG. 13 shows an example graphical interface 1300, in accordance with some embodiments. Graphical interface 1300 may include view 1302 of a virtual environment. Within view 1302, ghost avatar 1304 associated with a ghost user is shown such that the user (e.g., shown by avatar 1306) can race and/or otherwise measure performance against one or more ghost users.

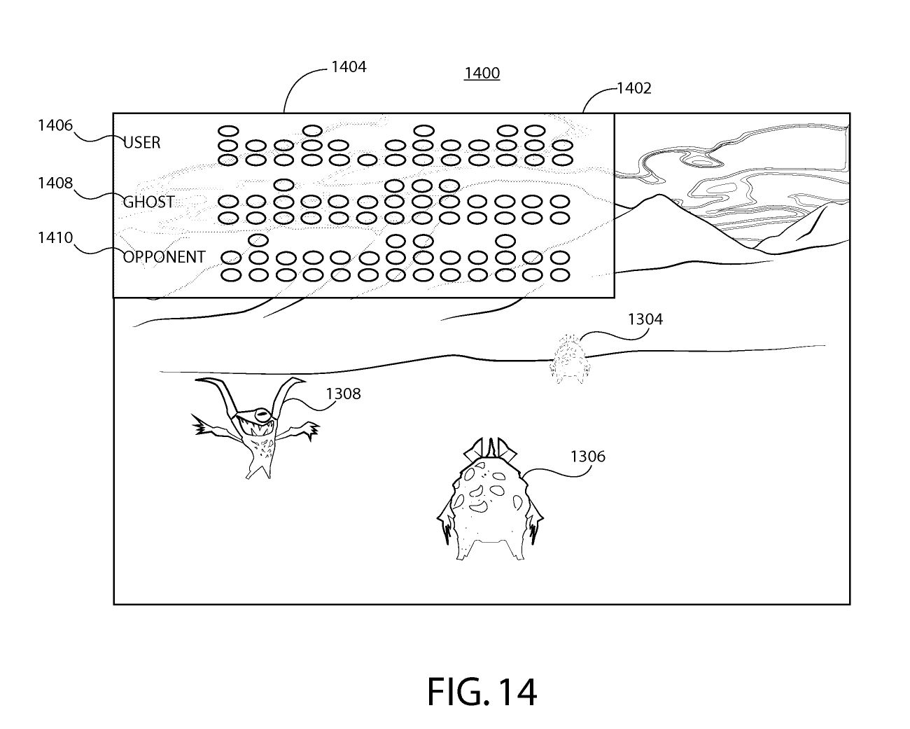

In some embodiments, mobile device 200 may be alternatively or additionally configured to provide the historical user performance data of one or more ghost users as a data and/or informational display to graphical interface (e.g., as an overlay within the view). In some embodiments, such as where the historical user performance data includes a time-based log, the data may be provided in the form of streaming information feeds, game length-synchronized charts (e.g., showing ghost performance score accumulation by the ghost user vs. the user's performance score accumulation at equivalent or comparable game length times), message and/or voice alerts (e.g., “you are 20 meters behind user X”), among other things. FIG. 14 shows an example graphical interface 1400, in accordance with some embodiments. Graphical interface 1400 may include view 1402 of a virtual environment. Within view 1402, informational overlay 1404 may provide user performance indication 1406 and ghost user performance indication 1408. In a racing-based game, for example, the user can compare progress and/or “race” with the ghost user based on informational overlay 1404 indicating the (e.g., time-synchronized and running) performance score of the ghost user against the performance score of the user. As shown in FIG. 14, in some embodiments, the display of performance scores may be based on exertion over time and/or actiplacement scores determined over time. Informational overlay 1404 may be configured to provide a time-synchronized display of performance scores to enhance user performance tracking in real-time and encourage personal improvement through competition.

At 812, mobile device 200 may be configured to determine a performance score based on the game objective data and the determined actiplacement scores. In some embodiments, the performance based score may additionally or alternatively be based on orientation data and/or user input data. For example, mobile device 200 may be configured to track user performance with respect to the one or more objectives defined by the game objective data to determine the performance score. In that sense, the performance score may provide a metric of user performance in an exercise game and/or serve as an indicator of user physical health or fitness.

At 814, mobile device 200 may be configured to generate user performance data based on the determined actiplacement scores. In some embodiments, the user performance data may include log data, time data, actiplacement scores, user motion data, orientation data, user input data, and/or other data indicative of user performance or behavior within the game session. Mobile device 200 may be further configured to provide the user performance data to central system 102 and/or another mobile device (e.g., for ghost mode game play by a different user against the user associated with the user performance data). In some embodiments, user avatars and/or user accounts may be associated with power levels, prestige levels, badges, or the like that can be earned through on user game play. Users may unlock rewards such as avatar modifications, accessories, clothing, tools, vehicles, etc. In some embodiments, the user may be allowed to capture an image of the user's face with the camera which may be rendered as part of the user avatar. Various rewards may be determined based on the user performance data indicating performance score goals, regularity of game play/exercise, performance, health, and/or fitness related improvements over time, among other things. In some embodiments, mobile device 200 may be configured to provide exercise games including single player-ongoing stories and escalating levels (e.g., determined based on user performance data).

At 816, mobile device 200 may be configured to perform some or all of the steps of method 600 and/or 700 with the historical user performance data (e.g., determined at 806) to provide a ghost graphical interface. In some embodiments, mobile device 200 may provide two different views of a virtual environment concurrently to the display device. The ghost graphical interface may include views of the virtual environment as traversed by the ghost user (e.g., the user or different user in a prior game session). The historical user performance data may include actiplacement scores, user motion data, orientation data, user input data, etc. that can be used to generate and/or provide the ghost graphical interface including the views of the virtual environment as traversed by the ghost user. For example, mobile device 200 may be configured to determine actiplacement scores based on the historical user motion data and advance views of the virtual environment variable amounts based on the determined actiplacement scores. In some embodiments, the historical user performance data may include a recorded video or the like. Here, mobile device 200 may be configured to provide the video to the ghost graphical interface. In some embodiments, where the historical user performance data includes a log

At 818, mobile device 200 may be configured to provide a ghost interface including the first graphical interface concurrently with the ghost graphical interface to the display device of mobile device 200. For example, the first graphical interface and the ghost graphical interface may respectively include first views of a virtual environment as traversed by the user (e.g., in real time) and second views of the virtual environment as traversed by the ghost user. In some embodiments, such as in a time-based game, the first views and the second views may be synchronized such that the user can quickly compare progress and/or “race” with the ghost user. Method 800 may proceed to 820 and end.

Returning to 804, in response to determining not to activate a ghost mode, method 800 may proceed to 822, where mobile device 200 may be configured to determine whether to activate a multiplayer mode. The multiplayer mode may allow the user to compete, such as in the racing and/or quest game, in real-time against one or more other users. Mobile device 200 may be configured to determine to activate the multiplayer mode in response to receiving a suitable user input. In response to determining to not activate the multiplayer mode, method 800 may return to 802, where mobile device 200 may be configured to receive game mode selection data. Some other example game modes may include a single player mode, such as a training mode (e.g., guiding the user through a map or course at various intensities of user motion), distance workout mode (e.g., traversing through a virtual environment for a set distance and/or time), etc.

In response to determining to activate the multiplayer mode, method 800 may proceed to 824, where mobile device 200 may be configured to establish a communication connection a second mobile device. For example, the communication connection may be established via network 104 and/or central system 102. In some embodiments, such as when mobile device 200 and/or the second mobile device are configured as thin clients (e.g., when some or all of the processing steps of methods 600, 700, and/or 800 are performed by server 108), the communication connection may be established via central system 102. For example, the mobile devices may be configured to provide user motion data, orientation, user input data, etc. to the central system and receive the graphical interfaces (e.g., in the form of display data) from central system 102.

At 826, mobile device 200 may be configured to perform method 600 and/or 700 to provide a graphical interface. The discussion at 810 may be applicable at 826. For example, the device 200 may be configured to provide one or more second user avatars to the graphical interface. A second user avatar may include an avatar previously selected by second user and/or may vary depending on the design, themes, settings, etc. of the exercise game (e.g., a human-like character, vehicle, etc.). Based on the second user performance data, mobile device 200 may be configured to traverse and/or rotate the ghost avatar within the view of the virtual environment. Here, for example, the user may be allowed to “race” against the second user, with the second user's live performance being represented by the second avatar within the first graphical interface. In some embodiments, one or more second users and/or ghost users may be included (e.g., via different sets of second user performance data and/or historical user performance data processed concurrently) within a game session such that the user can race against the one or more ghost users (e.g., at the same time) within the virtual environment. As shown in FIG. 13, view 1302 may include second user avatar 1308. Additionally or alternatively, the second user performance data of one or more second users may be provided as a data and/or informational overlay to graphical interface As shown in FIG. 14, informational overlay 1406 of view 1402 may include second user performance indication 1410.

At 828, mobile device 200 may be configured to receive second user performance data from the second mobile device. At 830, mobile device 200 may be may be configured to send user performance data to the second mobile device. The user performance data and/or second user performance data may include some or all of the various types of information discussed above at 806 and may be communicated via network 104 and/or central system 102. Via the exchange of user performance data between mobile device 200 and the second mobile device, the techniques discussed herein for mobile device 200 may also be performed by the second mobile device (e.g., second user plays on second mobile device with the first user). In some embodiments, mobile device 200 may be configured to establish communication connections with multiple other mobile devices. For a racing-based game, multiple users may race against each other's avatars, against computer controlled avatars, and/or ghost avatars.

In some embodiments, live users may be allowed to affect game play of each other. For example, a first user may pick up a bonus that slows down the traversal rate of a second user through the virtual environment. In another example, the first may reach a collectible item first, which can remove the item from the virtual environments of one or more other second users. In some embodiments, live users may interact with each other via user avatars in the virtual environment, but not with ghost avatars associated with ghost users and recorded performances.

At 832, mobile device 200 may be configured to perform some or all of 812-814 using the second user performance data as discussed at 812-814 for the historical user performance data. For example, the second user performance data may be used to provide a second user graphical interface that may include views of the virtual environment as traversed by the second user (e.g., in real-time). In some embodiments, mobile device 200 may be configured to provide the graphical interface concurrently with the opponent graphical interface to the display device. Method 800 may then proceed to 834 and end.

Many modifications and other embodiments will come to mind to one skilled in the art to which these embodiments pertain having the benefit of the teachings presented in the foregoing descriptions and the associated drawings. Therefore, it is to be understood that embodiments and implementations are not to be limited to the specific examples disclosed and that modifications and other embodiments are intended to be included within the scope of the appended claims. Although specific terms are employed herein, they are used in a generic and descriptive sense only and not for purposes of limitation.

That which is claimed:

1. A mobile device, comprising:
a display device configured to provide interactive displays
a motion detection device; and
circuitry configured to:
provide a graphical interface to the display device, wherein the graphical interface includes a view of a virtual environment defining a forward direction;
receive user motion data from the motion detection device;
determine, based on the user motion data, an actiplacement score indicating an intensity level of user movement; and
advance the view of the virtual environment in the forward direction at a variable amount based on the actiplacement score.

2. The mobile device of claim 1, wherein the motion detection device includes an accelerometer.

3. The mobile device of claim 2, wherein:
the user motion data includes an X axis magnitude value, a Y axis magnitude value, and a Z axis magnitude value; and
the circuitry is further configured to determine the actiplacement score based on one or more of the X axis magnitude value, the Y axis magnitude value, and the Z axis magnitude value.

4. The mobile device of claim 1, wherein the motion detection device includes a camera.

5. The mobile device of claim 4, wherein:
the user motion data includes a first image of the user and a second image of the user, wherein the first image is generated by the camera prior to the second image; and
the circuitry is further configured to determine the actiplacement score based on comparing the first image and the second image.

6. The mobile device of claim 1 further including a gyroscope and wherein the circuitry is further configured to:
associate the forward direction with an orientation of the mobile device;
receive orientation data from the gyroscope indicating a second orientation of the mobile device;
determine, based on the orientation data, a second view of the virtual environment defining a second forward direction; and
rotate the view of the virtual environment to the second view.

7. The mobile device of claim 1 further including a touch sensor and wherein the circuitry is further configured to:
receive orientation data from the touch sensor; and
determine, based on the orientation data, a second view of the virtual environment defining a second forward direction; and
rotate the view of the virtual environment to the second view.

8. The mobile device of claim 1, wherein the circuitry is further configured to determine a performance score based at least in part on actiplacement scores over time.

9. The mobile device of claim 1, wherein the circuitry is further configured to determine a performance score based at least in part on user interaction with the virtual environment via the mobile device.

10. The mobile device of claim 1, wherein the circuitry is further configured to:
determine a user difficulty setting; and
advance the view of the virtual environment in the forward direction at the variable amount based on the actiplacement score and the difficulty setting.

11. The mobile device of claim 1, wherein:
the graphical interface further includes a user avatar; and
the circuitry configured to advance the view of the virtual environment in the forward direction at the variable amount based on the actiplacement score includes the circuitry being configured to advance the user avatar in the forward direction at the variable amount.

12. The mobile device of claim 1, wherein the circuitry is further configured to:
generate user performance data based at least in part on the user motion data;
establish a communication connection with a second mobile device; and
provide the user performance data to the second mobile device.

13. The mobile device of claim 1, wherein the circuitry is further configured to:
receive, from a second mobile device, historical user performance data associated with a ghost user;
provide a ghost avatar of the ghost user to the view of the virtual environment; and
advance the ghost avatar within the view of the virtual environment based on the historical user performance data.

14. The mobile device of claim 1, wherein the circuitry is further configured to:
receive, from a second mobile device, historical user performance data associated with a ghost user;
provide a ghost graphical interface to the display device concurrently with the graphical interface, wherein the ghost graphical interface includes a second view of the virtual environment defining a second forward direction; and
advance the second view of the virtual environment in the second forward direction at a variable amount based on the historical user performance data.

15. The mobile device of claim 1, wherein the circuitry is further configured to:
receive, from a second mobile device, second user performance data associated with a second user;
provide a second user avatar of the second user to the view of the virtual environment; and
advance the second user avatar within the view of the virtual environment based on the second user performance data.

16. The mobile device of claim 1, wherein the circuitry is further configured to:
receive, from a second mobile device, second user performance data associated with a second user;
provide a second user graphical interface to the display device concurrently with the graphical interface, wherein the second user graphical interface includes a second view of the virtual environment defining a second forward direction; and
advance the second view of the virtual environment in the second forward direction at a variable amount based on the second user performance data.

17. The mobile device of claim 1, wherein the circuitry is further configured to:
receive calibration data indicating one or more user motion data values each associated with different intensity levels of user movement; and
adjust a programmatic relationship between the actiplacement score and the user motion data based on the calibration data.

18. A machine-implemented method for providing motion controlled virtual environment interaction, comprising:
providing, by circuitry, a graphical interface to a display device, wherein the graphical interface includes a view of a virtual environment defining a forward direction;
receiving user motion data from a motion detection device;
determining, based on the user motion data and by the circuitry, an actiplacement score indicating an intensity level of user movement; and
advancing the view of the virtual environment in the forward direction at a variable amount based on the actiplacement score.

19. The method of claim 18, wherein the motion detection device includes one or more of an accelerometer and a camera.

20. The method of claim 18 further comprising;
associating the forward direction with an orientation of the mobile device;
receiving orientation data from the gyroscope indicating a second orientation of the mobile device;
determining, based on the orientation data, a second view of the virtual environment defining a second forward direction; and
rotating the view of the virtual environment to the second view.
